(19) United States
(12) Patent Application Publication
(10) Pub. No.: US 2008/0130401 A1
(43) Pub. Date: Jun. 5, 2008

(54) Dosing system for loose compressible materials having heterogeneous granulometry and/or density

(76) Inventors: Francis Belanger, Riviere-Du-Loup (CA); Eric Houle, Bic (CA); Eric Viel, Riviere-Du-Loup (CA)

Correspondence Address: THE NATH LAW GROUP, 112 South West Street, Alexandria, VA, 22314, US

(21) Appl. No.: 11/984,433

(22) Filed: Nov. 16, 2007

Related U.S. Application Data
(60) Provisional application No. 60/859,256, filed on Nov. 16, 2006.

(51) Int. Cl. B01F 15/04; B01F 15/02

(52) U.S. Cl. 366/141; 366/160.1; 366/153.3; 366/160.5

(57) ABSTRACT

A dosing system for loose compressible material having heterogeneous granulometry and/or density and outputting the material though a main outlet is disclosed. The dosing system comprises a receiving structure for receiving the material to be dosed. A homogenizing system closes the receiving structure outlet and normalizes the material. A first conveying system acts as a base for the receiving structure, and transports the material towards the homogenizing system. A leveling adjustment system downstream of the homogenizing system levels the homogenized material. A second conveying system receives material from the homogenizing system and transports the material beyond the leveling adjustment system towards the main outlet. The homogenizing system, the leveling adjustment system and the second conveying system define a transition volume in which the material travels between the homogenizing system and the second conveying system. A method for dosing such a material is also disclosed.

### FIELD OF THE INVENTION

The present invention generally relates to an apparatus for dosing material, more particularly material such as compost, moss, garden soil, mulch and nuggets. More particularly, the invention relates to a system adapted for the treatment of loose compressible fibrous material, having naturally variable densities and granulometries, with the aim of measuring a specific quantity of the material by volume or by weight.

### BACKGROUND OF THE INVENTION

Precise dosage based on a volumetric or mass basis of bulk loose materials that are compressible, cohesive and isotropic in nature has always represented a challenge in industries having to manipulate and transform such products. Bagging of composts, potting soils and substrates are good illustrations of this problem. For the production of 30 liter bags on a conveyor producing 30 bags per minute, the variation of the average volume being bagged is in the order of plus or minus 10%. Such a variation has very important cost implications. In order to produce bags offering a volume equal or greater than 30 liters in 95% of cases, the manufacturer must aim to have an average amount of 33 liters for those bags. Assuming a hypothetical daily production rate of the order of 12,000 bags, the lack of precision of the dosage system leads to financial losses corresponding to the amount of 36,000 liters of materials per day. One must know that the dosage of a similar type of material on a mass basis offers similar problems of lack of precision.

Presently, equipments used to dose compost, potting soils and substrates are constituted of:
a buffer feeding container capable of receiving a given volume of material;
a material transport system at the base of the container, which is typically a conveyor or a conveying screw; and
adjustment systems for adjusting and standardizing the thickness of material being provided in order to obtain a feeding output that is as consistant as possible.

Dosage of materials is based on the control of stop and activation periods. Dosage on a volumetric basis is done through programming of the length of the stop and activation times, while dosage on a mass basis implies the use of a weighing device that causes stoppage or activation of the conveying system.

Variations observed in dosage also results from the nature of the product being manipulated. On one hand, products such as compost, potting soils and substrates are of a cohesive nature that can lead to the formation of aggregates. This phenomenon can be accentuated notably by the level of humidity observed locally. On the other hand, these products are easily compressible. Finally, input materials used in the fabrication of these products often present different granulometries and densities.

Moreover, it should be emphasized that the manipulation of such heterogeneous products in dosage equipment tends to accentuate heterogeneous phenomena. Indeed, one can observe at the level of the buffer container a differential compaction phenomenon depending on the thickness of the product present in the container and the location where the product is situated in the container, as shown in FIG. 1. The following table provides a legend to the different reference numbers used in FIG. 1:

| Number | Description |
|---|---|
| 100 | Densification against a plate |
| 102 | Aggregate |
| 104 | Gradient density in the container |
| 106 | Irregular profile |
| 108 | Constantly variable density and granulometry |
| 110 | Line of shearing stresses |
| 112 | Material with variable density and |
| | granulometry |

Furthermore, control of the thickness of the material at the output through a barrier mechanism causes a shearing phenomenon between the material in movement and the more stable material, thus causing the creation of new aggregates and zones of higher density. Displacement through a conveyor mechanism during a certain period of time of a given volume of product having heterogeneous granulometries and densities leads inevitably to variations in the dosed quantity.

It must also be mentioned that the reduced space given to dosage equipment (between 2 and 3 meters) in a transformation or packaging production line, increases greatly the complexity of the integration of a system for homogenization of the granulometry and density of the material in the dosage equipment. Moreover, this complexity is further increased by the fact that one must ensure that production speeds must offer performances of the order of 30 dosages or more per minute. Finally, dosage equipment must also ensure a conservation of a certain level of integrity of the fibrous nature or the texture of the material while ensuring homogeneity of the granulometry and of the density of the material.

Thus, there presently exists a need for a dosage apparatus for compressible materials that reduces variations in the dosed quantities while maintaining high production speeds.

### SUMMARY OF THE INVENTION

One of the objects of the present invention is to provide an apparatus that addresses this need.

More particularly, the principle of the present invention consists to add, to conventional dosage systems, additional steps for treatment of the material allowing a reduction and control of the variation of the granulometry and density of the material to be dosed before the thickness adjustment step of the material to be dosed. In addition to the three main parts of conventional systems, such as the buffer container, the system for adjustment of the thickness of the material and a material conveying system, the apparatus according to the present invention integrates additional systems located between the buffer container and the thickness adjustment system for the material to be dosed. These additional systems have the function of controlling the granulometry and density of the material before the step of controlling output from the apparatus.

More particularly, the present invention relates to a dosing system for loose compressible material having heterogeneous granulometry and/or density for outputting the material though a main outlet, comprising:
a receiving structure for receiving the material to be dosed, the receiving structure comprising a receiving structure outlet;
a homogenizing system closing the receiving structure outlet for homogenizing the material and feeding the material downstream;
a first conveying system acting as a base for the receiving structure, for transporting the material towards the homogenizing system;
a leveling adjustment system downstream of the homogenizing system for leveling the homogenized material; and a second conveying system for receiving material from the homogenizing system and transporting the material beyond the leveling adjustment system towards the main outlet,
   wherein the homogenizing system, the leveling adjustment system and the second conveying system define an upstream side, a downstream side and a bottom side respectively of a transition volume in which the material travels between the homogenizing system and the second conveying system.

The principle behind the operation of this apparatus is the following: the loose material arrives in the receiving structure through the top and accumulates within the structure. Preferably, a detection system of the top level of the product allows management of the arrival of the material in order to ensure that the receiving structure is never empty, nor too full.

Thereafter, the material exits the receiving structure, by a first conveying system located at the base of the receiving structure, preferably a conveyor belt. The material is then passed, completely or in part, through a homogenizing system. This homogenizing system allows homogenizing of the biggest particles of material from an average dimension controlled by the system. This homogenizing system has the effect of reducing the initial variation in the granulometry and density of the material. Moreover, the same mechanism allows elimination of non-controlled compaction effects of the material associated with shearing phenomena at the outlet of the receiving structure and due to differential pressure exerted on the material under the effect of its own weight.

Afterwards, the material preferably freefalls in a transition volume delimited by the homogenizing system, a leveling adjustment system and a second conveying system. The second conveying system is located at the base of the transition volume, and is preferably a conveyor belt. A detection system allows control of the level of material located inside the transition volume. The detection system maintains the desired level of product in the transition volume through control of the first conveying system speed located upstream thereof. By containing a minimal amount of material, the transition volume allows avoidance of the onset of non-controlled compaction zones that result from shearing phenomena or differential pressure exerted on the material under the effect of its own weight.

According to a preferred embodiment of the present invention, the first conveying system is located at a higher level than the transition volume in order to ensure that the material freefalls through gravity effects into the transition volume and thus ends the homogenizing process.

The material is transported by the second conveying system towards the main outlet of the dosing system. The quantity of material being transported is adjusted by a leveling adjustment system. The volume of dosed material is a function of the distance traveled and of the speed of the second conveying system.

Such a dosage system allows an increase in the levels of precision of the dosed quantity. In certain preferred embodiments, levels of precision of the order of 2% (average plus or minus to standard deviations) can be obtained, which represent increases in precision of the order of 8% with respect to prior art systems.

Advantageously, the addition of a homogenizing system combined with a transition volume, all located between the receiving container and the main outlet of a conventional dosing system allows a reduction and stabilization of the variations in the granulometry and density of the material and thus increases the level of precision of the dosage, all in a reduced amount of space of about 2 to 3 meters, which is normally allocated in prior art systems to dosage equipment for such materials.

The present invention also relates to a method for dosing loose compressible materials and for outputting the material through a main outlet, the method comprising the steps of:
a) receiving the material to be dosed in a receiving structure;
b) conveying the material in the receiving structure with a first conveying system towards a homogenizing system;
c) homogenizing the material with the homogenizing system; and
d) conveying the homogenized material beyond a leveling adjustment system for adjusting a thickness of the material, towards the main outlet.

A non-restrictive description of a preferred embodiment of the invention will now be given with reference to the appended drawings.

### BRIEF DESCRIPTION OF THE DRAWINGS

FIG. 1 is a side view of a prior art dosing system;

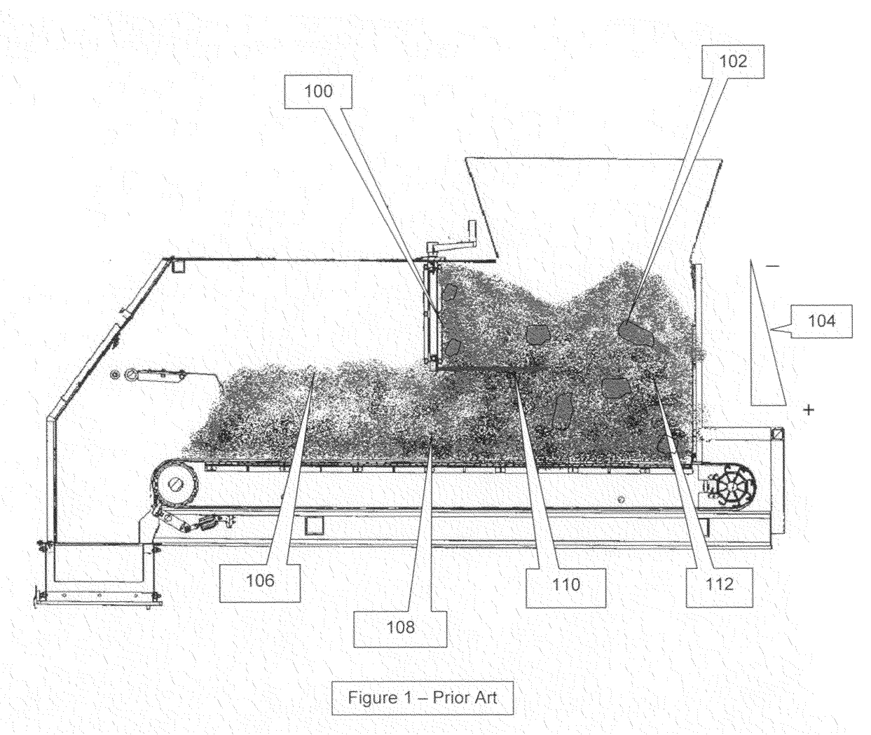

FIG. 2 is a perspective view of a dosing system according to a preferred embodiment of the present invention;

FIG. 3 is the same perspective view of the dosing system shown in FIG. 2 with elements removed in order to facilitate comprehension;

FIG. 4 is a side cut view of the dosing system shown in FIG. 2;

FIG. 5 is a top view of the dosing system shown in FIG. 2; and

FIG. 6 is a side cut view of the dosing system shown in FIG. 2 with a product circulating in the system.

### DESCRIPTION OF PREFERRED EMBODIMENTS

### List of Reference Numbers Used in the Figures

The elements of the system are identified in the figures by the following reference numbers as described in the table below:

| Number | Description |
|---|---|
| 10 | Receiving structure |
| 12 | First conveying system |
| 14 | Mechanical drive for driving the first |
| | conveying system |
| 16 | Starred-tool device (homogenizing |
| | system) |
| 20 | Vertical lateral walls |
| 22 | Level detector in the transition volume |
| 24 | Second conveying system |
| 26 | Mechanical drive for driving the |
| | second conveying system |
| 28 | Leveling adjustment system |
| 30 | Mechanical drive for the starred-tool |
| | device (homogenizing system) |
| 32 | Mechanical drive for the leveling |
| | adjustment system |
| 34 | Blocking trap at the main outlet |
| 36 | Main outlet |
| 40 | Transition volume |
| 42 | Height adjustment system for the |
| | leveling adjustment system |
| 44 | Starred-tool device pulley system |

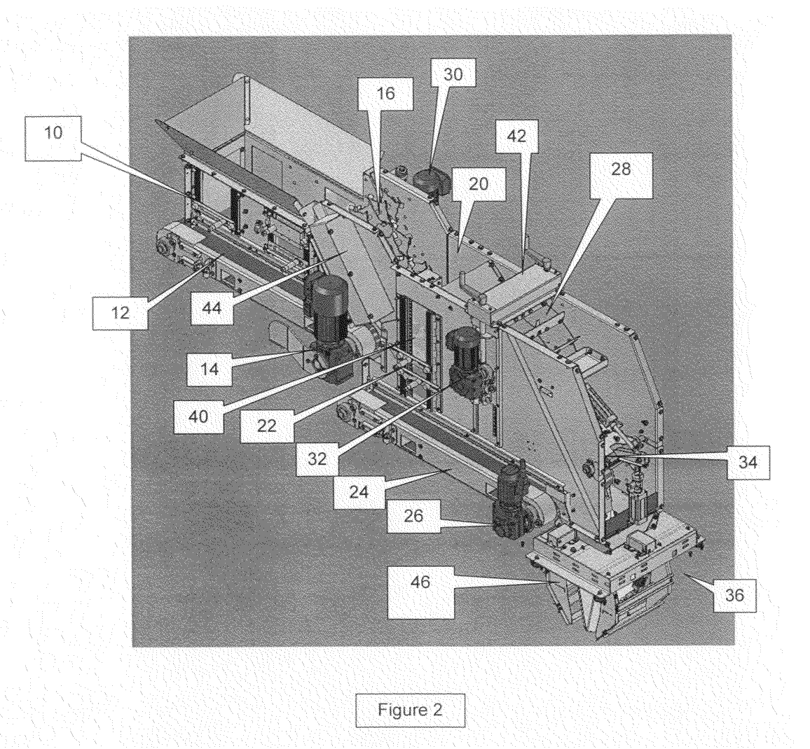

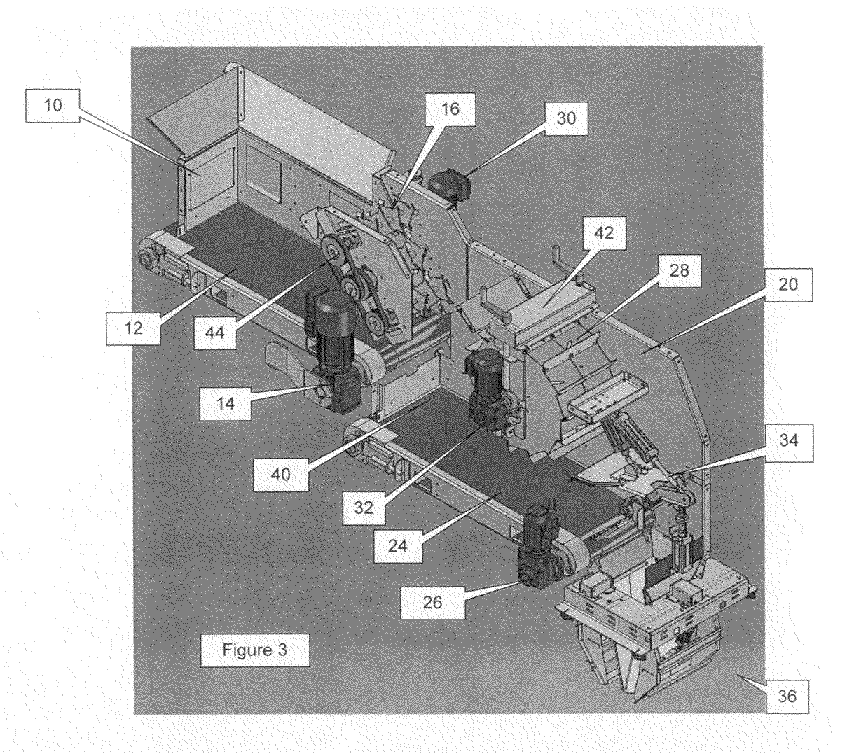

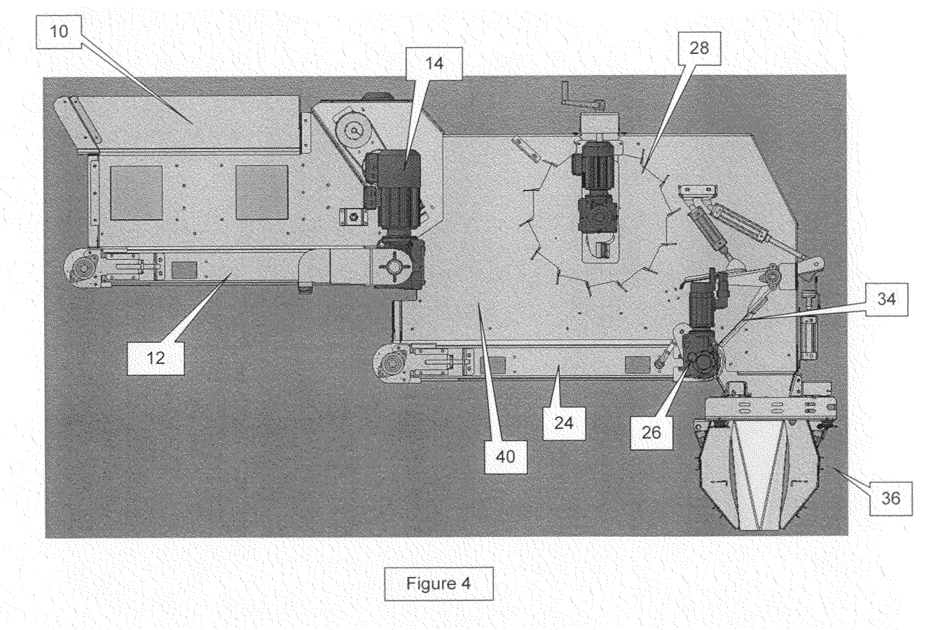

As shown in FIGS. 2 to 6, the dosage equipment for compressible material having heterogeneous granulometry and/or density comprises a receiving structure 10, also known as a feeding buffer container, having an inlet on the top thereof for the material to be dosed. This receiving structure 10 is delimited by two lateral plates and one rear plate. The base of the receiving structure 10 is closed by a first conveying system 12 comprising preferably a conveyor belt. It should be noted that any other means of transport or conveyor can be used. Moreover, the receiving structure 10 preferably comprises a first level detection system for detecting a level of material contained in the receiving structure.

A homogenizing system 16, such as a starred-tool device, closes the outlet of the receiving structure 10. This homogenizing system 16 allows homogenizing of the material before its dosage. By homogenizing, one means to give homogeneous properties to the material, wherein homogeneous properties include standard, controlled and constant density and granulometry. Consequently, larger particles of material are divided and given an average dimension, therefore limiting or reducing variations of the granulometry and density of the product. The homogenizing system 16 proposed in the preferred embodiment shown in the figures is a plurality of starred tools, spaced such that agglomerations of material over a predetermined size are separated by the plurality of starred tools before being fed to the transition volume. It should be noted however that any other homogenizing device known to the person of the art can be used without going beyond the scope of the present invention. According to another embodiment, the homogenizing system 16 comprises a plurality of rotating blade devices spaced such that, once again, agglomerations of material over a predetermined size are separated by the plurality of rotating blade devices before being fed to the transition volume 40.

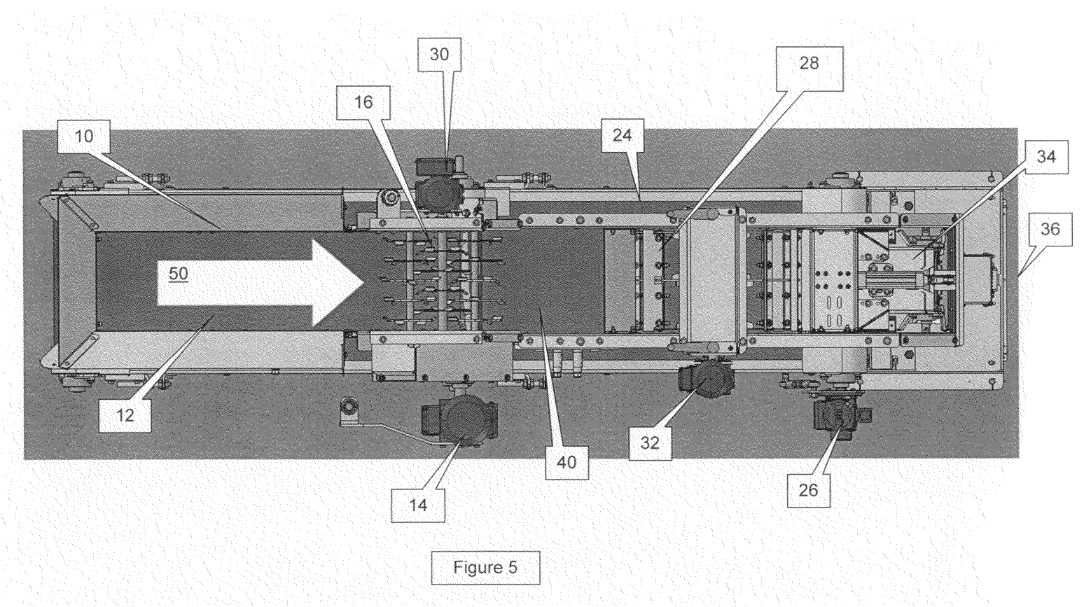

The receiving structure 10 allows containment of a variable volume of material to be dosed through time. The mechanical drive 14 drives the belt of the first conveying system 12. By advancing, the belt of the first conveying system 12 carries the product contained in the receiving structure 10 towards the homogenizing system 16. (Element 50 in FIG. 5 shows the direction of travel of the material.) The first conveying system 12 belt can be made of different materials and can have several different textures. The belt can also be made of chains or any other system that can transport the product towards the homogenizing system 16. In the case of the present invention, this belt is made of smooth rubber. The displacement speed of the belt is preferably variable in order to adjust the feeding output of the product towards the homogenizing system 16. Preferably, the different shafts of the starred-tool device are actuated rotatively by a mechanical drive 30 that actuates belts and pulleys 44 of equal or different sizes in order to allow equal or different speeds from one shaft to the other. By going through the homogenizing system 16, the product passes from the receiving structure 10 towards what is called a transition volume 40. The upstream, downstream and bottom sides of the transition volume 40 are defined by the homogenizing system 16, a leveling adjustment system 28 and a second conveying system 24 respectively. The material travels through this volume between the homogenizing system 16 and the second conveying system 24. The starred-tool device 16 is preferably placed at an angle but could also be vertical.

Preferably, the first conveying system 12 is located at a higher level than the transition volume 40 such that the material can freefall by gravity in the transition volume 40. The height difference is preferably of the order of 18 inches. The level of material in the transition volume 40 is controlled by a second level detection system 22. A second conveying system 24 is located under the transition volume 40. The material in the transition volume 40 is thus supported by a belt of the second conveying system 24. This belt moves thanks to mechanical drive 26. This mechanical drive 26 is preferably provided with a servomotor allowing control of speed in a precise manner. It should be noted however that in another embodiment of the invention that is not shown, the first conveying system and the second conveying system can be placed one after the other and may constitute one single conveying system including the homogenizing system and the transition volume. Preferably, the dosing system comprising a controller for controlling a material displacement speed of the first conveying system 12 based on a measurement of the second level of material contained in the transition volume 40 made by the second level detection system 22. For example, the material displacement speed of the first conveying system 12 can be increased if the second level of material decreases below a given threshold.

By advancing, the belt of the second conveying system 24 transports the material against the leveling adjustment system 28. Lateral walls 20 close the two sides of the second conveying system 24. These walls 20 are preferably parallel and vertical but could have a slight angle towards the outside of the system and the direction of travel of the material.

Preferably, the second conveying system 24 is also provided with a leveling adjustment system 28 that can be made of several blades fixed on a rotating shaft. This leveling adjustment system 28 is provided with a height adjustment mechanism 42 for adjusting the vertical position of the leveling adjustment system within the dosing system. The leveling adjustment system 28 is rotatively driven by a mechanical drive 32. The mechanical drive 32 is built in order to allow functioning of the leveling system 28 without any adjustments when the leveling system 28 is displaced vertically with the height adjustment mechanism 42.

Preferably, the second conveying system 24 can also comprise a blocking trap 34 near the main outlet 36 and located at an extremity of the second conveying system. The blocking trap can comprise a catch gate used when operating the system on a weight basis and a cutting gate used when operating the system on a volumetric basis. Only one of the catch or cutting gates is used at a time. At this point, the material can either be directed towards other conveyors, weighed or placed directly into bags. Optionally, a weighing bin 46 for weighing a quantity material exiting the main outlet may be provided.

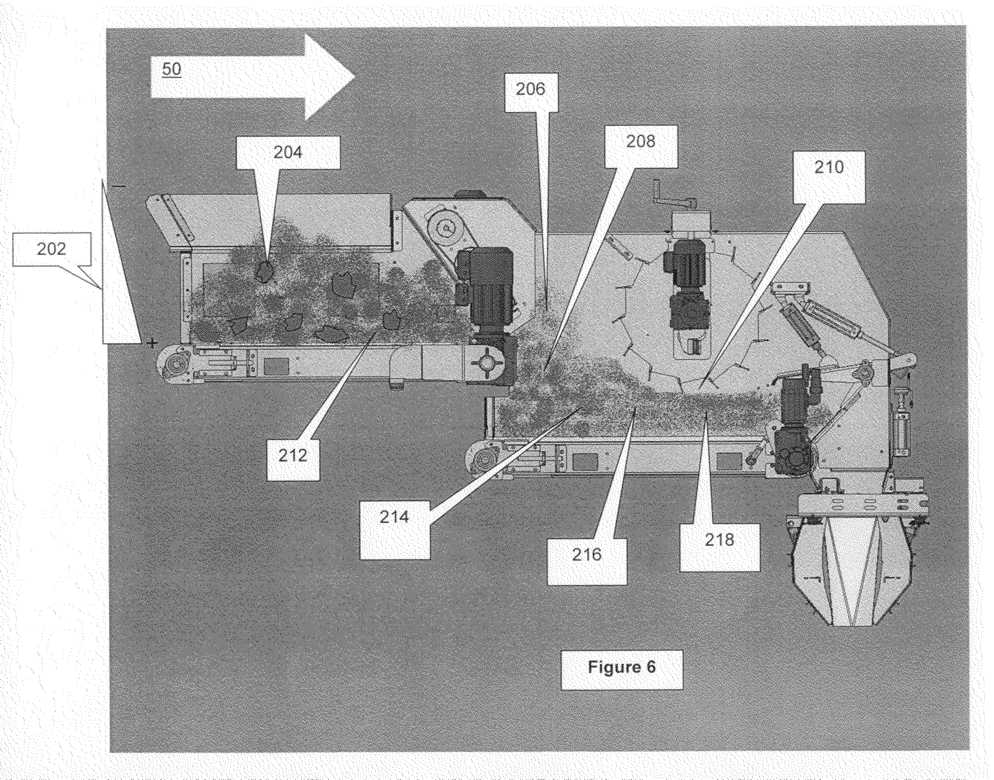

FIG. 6 illustrates how material travels within the system. The following table provides a legend to the different reference numbers used in FIG. 6:

| Number | Description |
|---|---|
| 50 | Direction of travel of the material |
| 202 | Gradient density in the receiving structure |
| 204 | Aggregate |
| 206 | Uniform density and granulometry at the exit of |
| | the homogenizing system |
| 208 | Freefall of the material to complete the |
| | homogenizing |
| 210 | Leveling and adjustment of the height for |
| | output control |
| 212 | Zone of high density |
| 214 | Uniform density and granulometry maintained |
| | in the transition volume |
| 216 | Small volume of material, minimizing shear |
| | stresses |
| 218 | Bed of uniform material on the second |
| | conveying system |

The present invention also provides a method for dosing loose compressible materials and for outputting the material through a main outlet. The method comprises a number of basic steps to which a number of optional steps may be added. The method comprising the steps of:
a) receiving the material to be dosed in a receiving structure;
b) conveying the material in the receiving structure with a first conveying system towards a homogenizing system;
c) homogenizing the material with the homogenizing system; and
d) conveying the homogenized material beyond a leveling adjustment system for adjusting a thickness of the material, towards the main outlet.

Preferably, the method further comprises a step of controlling a first level of material contained in the receiving structure.

Preferably, the method further comprises a step of controlling a second level of material contained in a transition volume between the homogenizing system and the leveling adjustment system.

Preferably, the method further comprises a step of controlling a vertical position of the leveling adjustment system within the dosing system.

Preferably, the method further comprises a step of controlling a material displacement speed of the first conveying system based on a measurement of the second level of material contained and detected in the transition volume.

It is to be noted that although a preferred embodiment of the invention has been described in detail hereinabove and illustrated in the appended drawings, the invention is not limited to this single embodiment and several changes and modifications can be carried out by a person of the art without departing from the scope or spirit of the invention.

1. A dosing system for loose compressible material for outputting the material through a main outlet, comprising:
a receiving structure for receiving the material to be dosed, the receiving structure comprising a receiving structure outlet;
a homogenizing system closing the receiving structure outlet for homogenizing the material and feeding the material downstream;
a first conveying system acting as a base for the receiving structure, for transporting the material towards the homogenizing system;
a leveling adjustment system downstream of the homogenizing system for leveling the homogenized material; and
a second conveying system for receiving material from the homogenizing system and transporting the material beyond the leveling adjustment system towards the main outlet,
wherein the homogenizing system, the leveling adjustment system and the second conveying system define an upstream side, a downstream side and a bottom side respectively of a transition volume in which the material travels between the homogenizing system and the second conveying system.

2. The dosing system according to claim 1, wherein the receiving structure further comprises a first level detection system for detecting a first level of material contained in the receiving structure.

3. The dosing system according to claim 1, wherein the first conveying system is located above the second conveying system such that the material freefalls between the homogenizing system and the second conveying system.

4. The dosing system according to claim 1, further comprising a second level detection system for detecting a second level of material contained in the transition volume.

5. The dosing system according to claim 1, wherein the leveling adjustment system comprises a plurality of blades mounted on a rotating shaft.

6. The dosing system according to claim 1, wherein the homogenizing system comprises a plurality of starred tools spaced such that agglomerations of material over a predetermined size are separated by the plurality of starred tools before being fed to the transition volume.

7. The dosing system according to claims 1, wherein the first conveying system and the second conveying system each comprise a conveyor belt.

8. The dosing system according to claim 1, further comprising a vertical adjustment system for adjusting a vertical position of the leveling adjustment system within the dosing system.

9. The dosing system according to claim 1, wherein the homogenizing system comprises a plurality of rotating blade devices spaced such that agglomerations of material over a predetermined size are separated by the plurality of rotating blade devices before being fed to the transition volume.

10. The dosing system according to claim 1, further comprising a blocking trap proximate the main outlet.

11. The dosing system according to claim 4, further comprising a controller for controlling a material displacement speed of the first conveying system based on a measurement of the second level of material contained in the transition volume made by the second level detection system.

12. The dosing system according to claim 1, further comprising a weighing bin for weighing a quantity material exiting the main outlet.

13. A method for dosing loose compressible materials and for outputting the material through a main outlet, the method comprising the steps of:
a) receiving the material to be dosed in a receiving structure;
b) conveying the material in the receiving structure with a first conveying system towards a homogenizing system;
c) homogenizing the material with the homogenizing system; and
d) conveying the homogenized material beyond a leveling adjustment system for adjusting a thickness of the material, towards the main outlet.

14. The method according to claim 13, further comprising a step of controlling a first level of material contained in the receiving structure.

15. The method according to claim 13, further comprising a step of controlling a second level of material contained in a transition volume between the homogenizing system and the leveling adjustment system.

16. The method according to claim 13, further comprising a step of controlling a vertical position of the leveling adjustment system within the dosing system.

17. The method according to claim 15, further comprising a step of controlling a material displacement speed of the first conveying system based on a measurement of the second level of material contained and detected in the transition volume.

18. The dosing system according to claim 11, wherein the homogenizing system comprises a plurality of rotating blade devices spaced such that agglomerations of material over a predetermined size are separated by the plurality of rotating blade devices before being fed to the transition volume.

19. The dosing system according to claim 18, wherein the first conveying system is located above the second conveying system such that the material freefalls between the homogenizing system and the second conveying system.

20. The dosing system according to claim 19, further comprising a vertical adjustment system for adjusting a vertical position of the leveling adjustment system within the dosing system.
